(19) United States
(12) Patent Application Publication
(10) Pub. No.: US 2004/0080493 A1
(43) Pub. Date: Apr. 29, 2004

(54) Index-finger computer mouse

(76) Inventor: Shahar Kenin, Hod HaSharon (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 10/279,800

(22) Filed: Oct. 25, 2002

(51) Int. Cl. G09G 5/08

(52) U.S. Cl. 345/163

(57) ABSTRACT

A miniature, finger computer mouse is provided, arranged as a sleeve, for wearing on the index finger, at a natural anatomic resting position of the thumb on the finger. Mouse manipulation is achieved by the combined action of the thumb and the index finger, which is controlled by the intrinsic musculature of the hand and is more accurate and more sensible to joint movement than the extrinsic extensors muscles of the forearm. Overuse and overload of the tendons of the upper extremity, and in particular of the forearm, and their consequential orthopedic disorders, are avoided.

### FIELD AND BACKGROUND OF THE INVENTION

The present invention relates to a computer mouse and more particularly, to a miniature computer mouse, arranged about the mid interphalngeal section (middle phalanx) of the index finger, and manipulated by the combined action of the thumb and the index finger.

Overuse and overload of the tendons of the upper extremity, and in particular of the forearm, may lead to orthopedic disorders, such as the carpal tunnel syndrome, tendinitis and bursitis The handling of a standard computer mouse can cause such overuse and overload and lead to these orthopedic disorders.

Using a standard computer mouse involves the forearm and finger extensors, whose tendons cross at the wrist joint, as seen in FIG. 1. (F. H. Netter and A. D. Dalley II, Atlas of Human Anatomy, 2d Edition, MediMedia USA, 1989, plate 439.) Overloading these muscles creates friciton forces on their tendons and may lead to wrist-joint pain, causing, for example, carpal tunnel syndrome, bursitis, and (or) tendinitis.

The forearm and finger extensors originate at the forearm bones—the ulna and the radius, as seen in FIG. 2 (ibid, plate 411), but some extensors cross the elbow joint. In consequence, tendinitis of the forearm extensor at the point of origin may occur, a condition known as “tennis elbow”, which is common among people who use computers with a standard mouse extensively.

Among the more sensitive muscles which may be overloaded, when using a standard computer mouse extensively, are the extensor indicis tendon and the extensor digitorium tendon, which extends the index finger. These two tendons are very active as the index finger is extended twice in the double-click action. Not only does the repetitive action likely to damage the delicate tendons, but also, hypertrophy of the muscles may occur, increasing the friction of the muscles in their points of origin.

Furthermore, as seen in FIG. 3, the use of a standard computer mouse tends to shift the upper extremity forward, creating a loading on the shoulder and neck musculature of the dominant side. For many extensive computer users using a standard mouse, the stiffness of the musculature in the dominant side (depending on whether the person is left or right handed) is obvious.

U.S. Pat. No. 6,154,199, to Butler, describes a computer mouse arranged on a glove, wherein tracking motion is provided by the thumb acting against the index finger. However, the position of the tracking roller is on the proximal interphalngeal section, which assumes operation with the hand outstretched. This approach causes tension on the extensor pollicis longus and on the brevis tendons; therefore, it is poor from ergonomic considerations. Furthermore, clicking operations are provided by actions of the fingers against the palm, causing an overuse of the forearm flexors tendons, which may lead to carpal tunnel syndrome. Additionally, Butler requires wearing a glove, which may be rather cumbersome.

U.S. Pat. No. 6,297,808, to Yang, describes a hand controller, arranged as a ring. But no attention is drawn to the exact location of the ring on the finger, or fingers, and the system is not designed ergonomically.

U.S. Pat. No. 5,638,092, to Eng et al, involves a finger-mounted cursor-control devices. However, it does not include other mouse functions.

U.S. Pat. No. 5,481,265, to Russel involves a finger-mounted computer control device, held between a thumb and an index finger. However, it is not intended as a mouse; rather, it provides a new approach to user-computer interface.

There is thus a widely recognized need for, and it would be highly advantageous to have, a computer mouse devoid of the above limitations.

### SUMMARY OF THE INVENTION

According to one aspect of the present inveniton, there is thus provided a finger mouse, worn on a finger of a user and operative with a computer, said finger mouse comprising:

a substrate;

a tracking roller, arranged on said substrate, for producing signals that control movements of a cursor on a screen of said computer;

a first switch, arranged on said substrate, for producing signals that control left-key mouse functions;

a second switch, arranged on said substrate, for producing signals that control right-key, mouse functions;

a communication provider, for transmitting said signals to said computer; and

a power provider, for providing power to said tracking roller, said first and second switches, and said communication provider,

wherein said finger mouse is adapted to be worn at a natural anatomic resting position of the thumb on the finger, and wherein said finger mouse is manipulated by a combined action of the thumb and the finger.

According to an additional aspect of the present inveniton, said tracking roller and a switch, selected from the group consisting of said first and second switches, are incorporated together.

According to still an additional aspect of the present inveniton, said finger mouse further includes a scrolling roller, manipulated by the combined action of the thumb and the finger.

According to yet an additional aspect of the present inveniton, said scrolling roller and a switch, selected from the group consisting of said first and second switches, are incorporated together.

According to still an additional aspect of the present inveniton, said finger mouse further includes a lateral scrolling roller and a vertical scrolling roller.

According to yet an additional aspect of the present inveniton, said substrate is arranged on a sleeve that is worn about the finger.

According to still an alternative aspect of the present inveniton, said substrate is arranged as a thimble that is worn about the finger.

According to an additional aspect of the present inveniton, said finger mouse further includes an inner, absorbent layer, placed between said substrate and the finger.

According to still an additional aspect of the present inveniton, said communication and power providers are arranged as:

a first cable, leading from said finger mouse to a mouse extension cable; and

said finger mouse extension cable, leading from said first cable to said computer,

wherein a connection point between said first cable and said finger mouse extension cable is easily accessible to a user.

According to an alternative aspect of the present inveniton, said communication and power providers are arranged on a wrist band, on the hand on which said finger mouse is worn, and wherein said communication and power providers are connected to said finger mouse by a cable.

According to yet an alternative aspect of the present inveniton, said communication and power providers are arranged on the user's person, and wherein said communication and power providers are connected to said finger mouse by a cable.

According to an additional aspect of the present inveniton, said communication provider is a miniature transmitter, incorporated with said finger mouse.

According to still an additional aspect of the present inveniton, said power provider is at least one miniature battery, incorporated with said finger mouse.

According to yet an additional aspect of the present inveniton, said power provider is at least one miniature paper-thin battery, incorporated with said finger mouse.

According to still an additional aspect of the present inveniton, said finger mouse is provided as an open strip, adapted to be fastened around the finger.

According to yet an additional aspect of the present inveniton, said finger mouse is provided in a range of sizes.

According to another aspect of the present inveniton, there is thus provided a finger mouse, adapted to be held between a thumb and at least one finger of a user and operative with a computer, said finger mouse comprising:

a substrate;

a tracking roller, arranged on said substrate, for producing signals that control movements of a cursor on a screen of said computer;

a first switch, arranged on said substrate, for producing signals that control left-key mouse functions;

a second switch, arranged on said substrate, for producing signals that control right-key, mouse functions;

a communication provider, for transmitting said signals to said computer; and

a power provider, for providing power to said tracking roller, said first and second switches, and said communication provider,

wherein said finger mouse is adapted to be held at a natural anatomic gripping position of the thumb on the finger, and wherein said finger mouse is manipulated by a combined action of the thumb and the at least one finger.

According to still an additional aspect of the present inveniton, said finger mouse is shaped after a mold of an inner space within a hand, when in a soft gripping position.

According to yet an additional aspect of the present inveniton, said finger mouse is provided in a range of sizes.

According to still another aspect of the present inveniton, there is thus provided a method of controlling a computer mouse by the intrinsic musculature of the hand, said method comprising:

providing a finger mouse, worn on a finger of a user and operative with a computer, said finger mouse comprising:

a substrate;

a tracking roller, arranged on said substrate, for producing signals that control movements of a cursor on a screen of said computer;

a first switch, arranged on said substrate, for producing signals that control left-key mouse functions;

a second switch, arranged on said substrate, for producing signals that control right-key, mouse functions;

a communication provider, for transmitting said signals to said computer; and

a power provider, for providing power to said tracking roller, said first and second switches, and said communication provider,

wherein said finger mouse is adapted to be worn at a natural anatomic resting position of the thumb on the finger, and wherein said finger mouse is manipulated by a combined action of the thumb and the finger;

positioning said finger mouse on the finger, at a natural anatomic resting position of the thumb on the finger; and

manipulating said finger mouse by the combined action of the thumb and the finger.

According to an additional aspect of the present inveniton, the finger is an index finger.

According to an alternative aspect of the present inveniton, the finger is a middle finger.

According to yet another aspect of the present inveniton, there is thus provided a method of controlling a computer mouse by the intrinsic musculature of the hand, said method comprising:

providing a finger mouse, adapted to be held between a thumb and at least one finger of a user and operative with a computer, said finger mouse comprising:

a substrate;

a tracking roller, arranged on said substrate, for producing signals that control movements of a cursor on a screen of said computer;

a first switch, arranged on said substrate, for producing signals that control left-key mouse functions;

a second switch, arranged on said substrate, for producing signals that control right-key, mouse functions;

a communication provider, for transmitting said signals to said computer; and

a power provider, for providing power to said tracking roller, said first and second switches, and said communication provider,

wherein said finger mouse is adapted to be held at a natural anatomic gripping position of the thumb on the finger, and further wherein said finger mouse is manipulated by a combined action of the thumb and the at least one finger;

positioning said finger mouse between the thumb and the at least one finger, at a natural anatomic resting position of the thumb on the at least one finger; and

manipulating said finger mouse by the combined action of the thumb and the at least one finger.

According to an additional aspect of the present inveniton, the at least one finger is an index finger.

According to an alternative aspect of the present inveniton, the at least one finger is a middle finger.

According to still an alternative aspect of the present inveniton, the at least one finger includes an index finger and a middle finger.

The present invention successfully addresses the shortcomings of the presently known configurations by providing a miniature, finger computer mouse, arranged as a sleeve, for wearing on the index finger, at a natural anatomic resting position of the thumb on the finger. Mouse manipulation is achieved by the combined action of the thumb and the index finger, which is controlled by the intrinsic musculature of the hand and is more accurate and more sensible to joint movement than the extrinsic extensors muscles of the forearm. Overuse and overload of the tendons of the upper extremity, and in particular of the forearm, and their consequential orthopedic disorders, are avoided.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an illustration of a wrist section;

FIG. 2 is an illustration of forearm and extrinsic hand extensor muscles and tendons;

FIG. 3 is a schematic illustration of the effect of a prior art mouse on the neck and shoulder blades;

FIGS. 4A-4J are schematic illustrations of an index-finger computer mouse, in accordance with preferred embodiments of the present invention;

FIG. 5 is a cross sectional view of an index-finger computer mouse, on an index finger, in accordance with a preferred embodiment of the present invention;

FIG. 6 is an illustration of the intrinsic musculature of the hand;

FIG. 7 is an illustration of the sensory humunculus;

FIG. 8 is an illustration of the motor homunculus;

FIG. 9 is a schematic illustration of a miniature computer mouse, adapted to be held between the thumb and the fingers, in accordance with another preferred embodiment of the present invention; and

FIG. 10 is a schematic illustration of a miniature computer mouse, adapted to be held between the thumb and the fingers, in accordance with still another preferred embodiment of the present invention

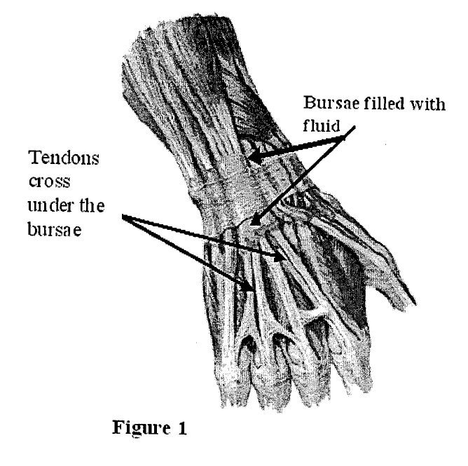

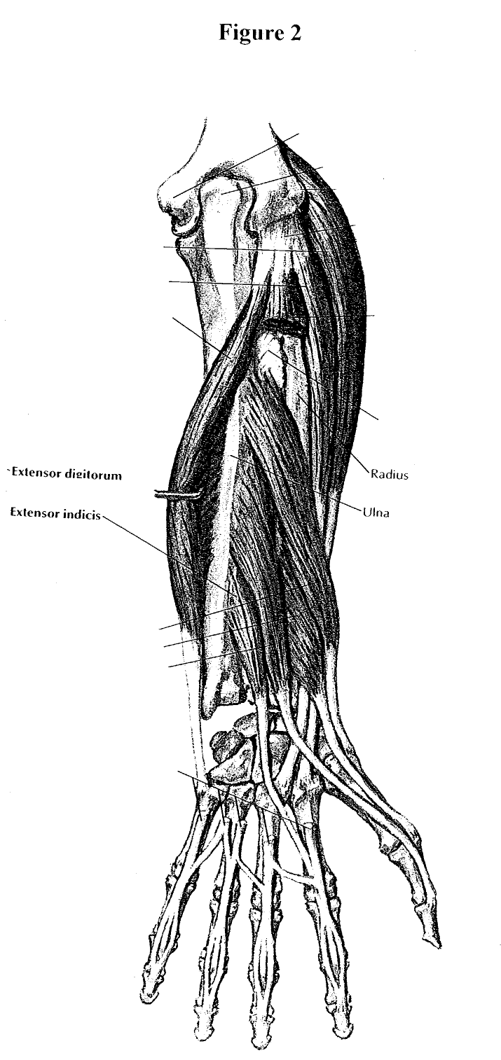

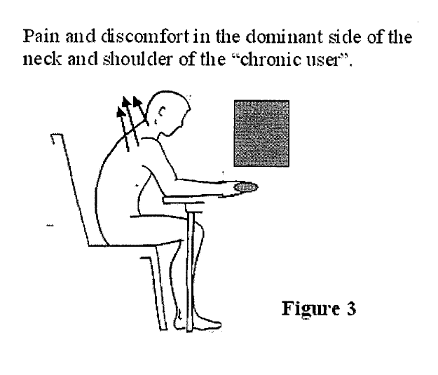

### DESCRIPTION OF THE PREFERRED EMBODIMENTS

The present invention is of a miniature, finger computer mouse, arranged as a sleeve, for wearing on the index finger, at a natural anatomic resting position of the thumb on the finger. Specifically, mouse manipulation is controlled by the intrinsic musculature of the hand, which is more accurate and more sensible to joint movement than the extrinsic extensors muscles of the forearm. (E. R. Kandel, J. H. Schwartz and T. M. Jessell, “Principles of Neural Science,” 3^{rd} edition, Appleton & Lange, 1991, Simon & Schuster Business and Professional Group, chapter 26, pp. 367-384, and chapter 40, pp. 609-611.) Overuse and overload of the tendons of the upper extremity, and in particular of the forearm, and their consequential orthopedic disorders, such as the carpal tunnel syndrome, tendinitis and bursitis, are avoided.

The principles and operation of the miniature, index-finger computer mouse according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

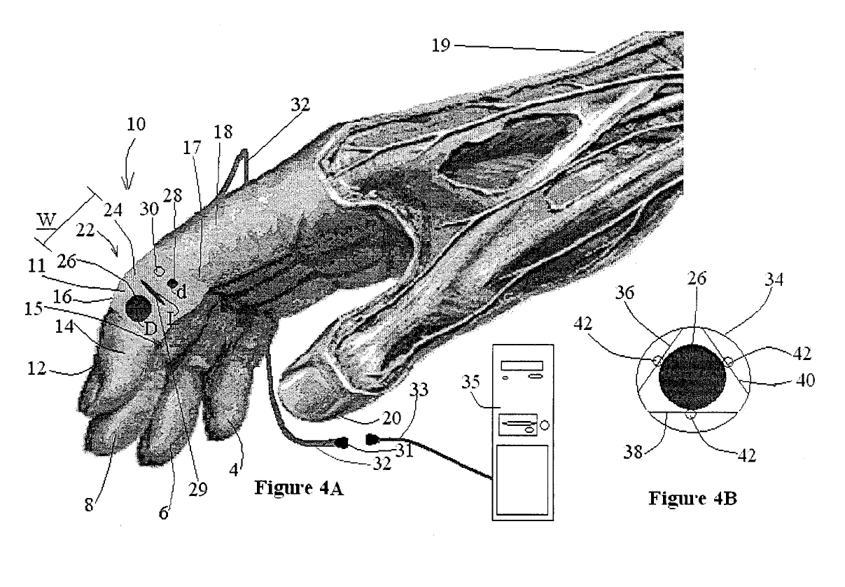

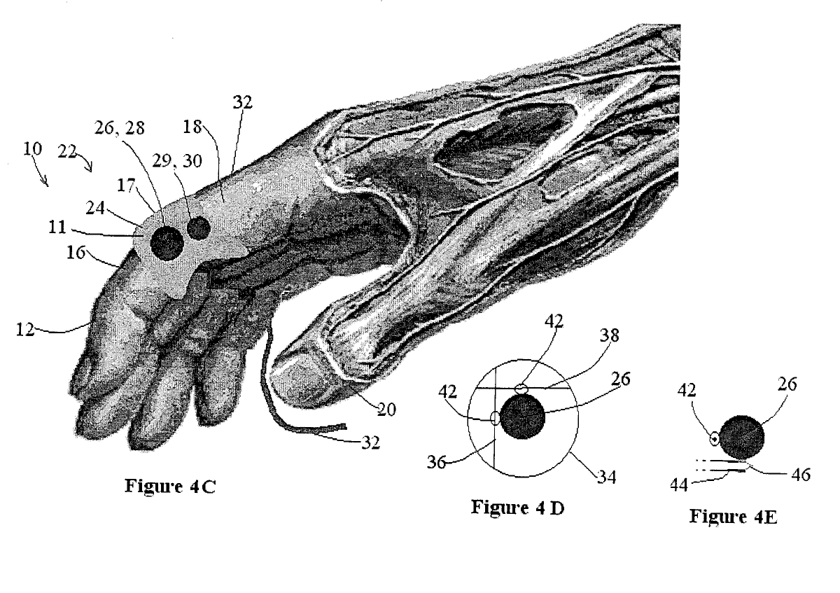

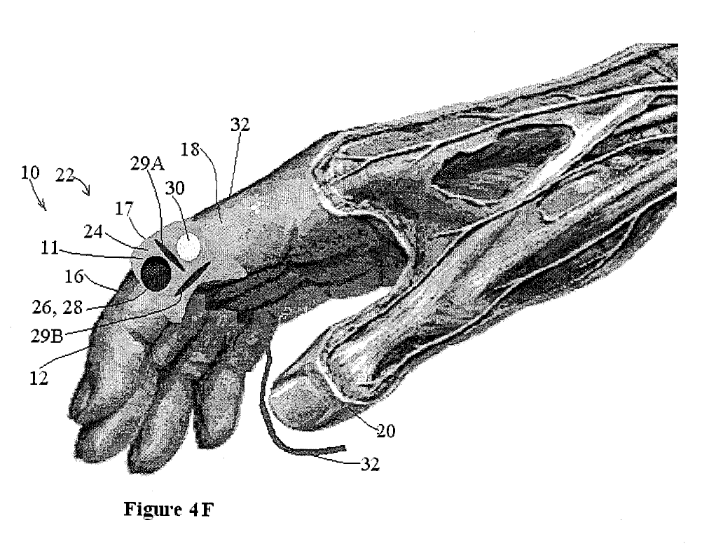

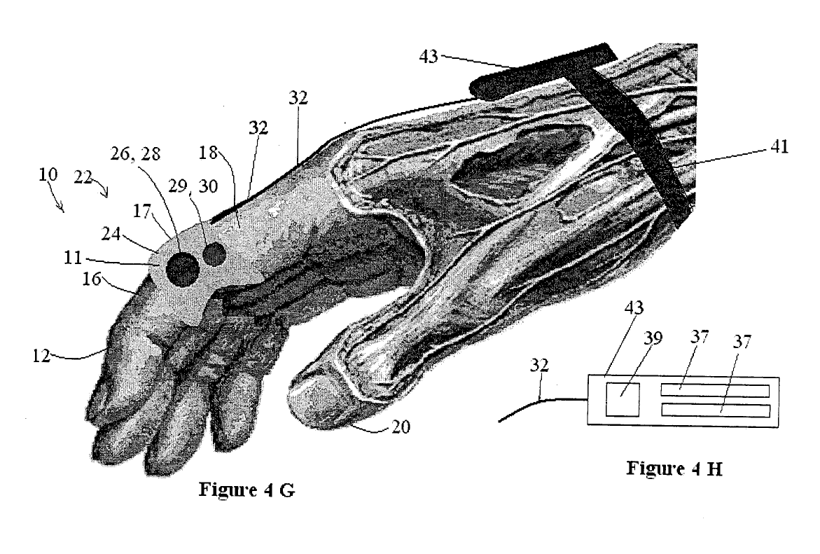

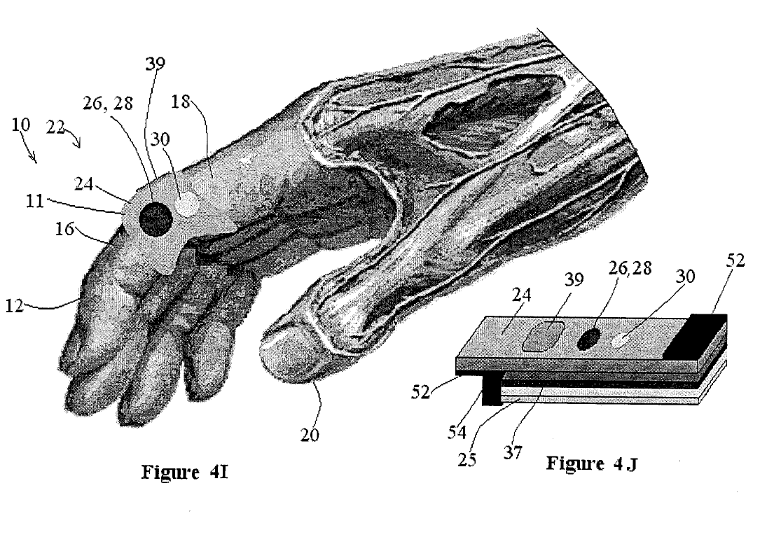

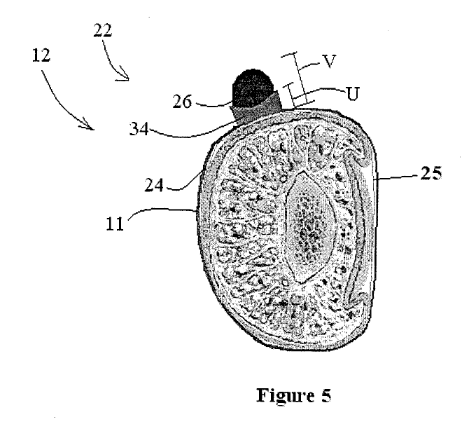

Referring now to the figures, FIG. 4A is a schematic illustration of a hand 10, on which an index-finger computer mouse 22 is positioned, in accordance with a preferred embodiment of the present invention. Hand 10 has an index finger 12, comprising distal, mid and proximal interphalngeal sections 14, 16, and 18, with respect to a wrist 19, and distal and proximal interphalngeal joints 15 and 17. Additionally, hand 10 includes a thumb 20, a middle finger 8, a ring finger 8 and a pinky 4, each having joints and sections as above. Finger mouse 22 is arranged on a substrate 11, which is preferably formed as a sleeve 24, worn around index finger 12.

In accordance with a preferred embodiment of the present invention, finger mouse 22 is worn on index finger 12, at the natural anatomic resting position of thumb 20 on index finger 12, for example, around mid interphalngeal section 16, as seen in FIG. 4A.

It will be appreciated that due to differences in individual pereferences, some people may find wearing sleeve 24 somewhat above or below mid interphalngeal section 16 more comfortable. For example, some people may prefer wearing sleeve 24 on any one of proximal interphalngeal joint 17 (seen hereinbelow, in conjunction with FIG. 4C), distal interphalngeal joint 15, distal interphalngeal section 14, or a combination of a section and an adjacent joint.

In accordance with other embodiments of the present invention, finger mouse 22 may be arranged on a finger other than the index finger. For example, finger mouse 22 may be arranged on middle finger 8, at the natural anatomic resting position of thumb 20 on middle finger 8, and manipulated by the combined action of the thumb and the middle finger.

In accordance with other embodiments of the present invention, sleeve 24 may extend the length of the finger. Alternatively, sleeve 24 may be arranged as a thimble 24.

Preferably, sleeve 24, or thimble 24, are formed of an elastic, biologically inert material, for example, silicon, or natural rubber. Alternatively, sleeve 24 or thimble 24 may be formed of a metal, wood, a rigid plastic, or the like. Sleeve 24 may be formed as a ring 24 which may further be adjustable. Aternatively, sleeve 24 may be formed as a strip of tough fabric, positioned on index finger 12 with Velcro, a snap, or the like, to form the sleeve.

A width W of sleeve 24 may be about 1-4 cm, and preferably about 1.5-2 cm. It will be appreciated that somewhat larger or smaller dimensions are possible.

In accordance with a preferred embodiment of the present invention, index-finger computer mouse 22 comprises a tracking roller 26, for controlling movements of a cursor on a screen (not shown), a first switch 28, for performing left-key, mouse functions, and a second switch 30, for performing right-key, mouse functions. Mouse 22 may further include a scrolling roller 29, for page-up and page-down scrolling operations.

Power and communication providers, arranged as a cable 32, having a mouse connector 31, provide power to mouse 22 and communication between mouse 22 and a computer 35.

In accordance with a preferred embodiment of the present invention, tracking roller 26 has a diameter D of about 5 mm, scrolling roller 29 has a length L, of about 5-8 mm, and first and second switches 28 and 30 have diameters d, of about 2-3 mm. It will be appreciated that somewhat larger or smaller dimensions are possible. It will be further appreciated that first and second switches 28 and 30 need not be equal in size.

Preferably, connector 33 of cable 32 is adapted either to connect directly to computer 35, or to connect to a mouse extension cable 33, which leads to computer 35. Mouse extension cable 33 is provided so that a user (not shown) may easily connect and disconnect mouse 22 from computer 35, for example, when rising for a short break.

A particular advantage of index-finger computer mouse 22, when compared to common mouse, is that the user need not move his hand far from the keyboard, in order to perform mouse operations, but merely raise his hand slightly. The user may even continue to type with his other hand.

More important, since the mouse is on the user's person, the user need not bend down over the desk, for mouse operations. Rather, the user may lean back and sit comfortably, while operating mouse 22.

It will be appreciated that since the operation of finger-index mouse 22 does not require the proximity of a flat working surface, the user may operate finger-index mouse 22, while sitting in an armchair, or on a sofa, and positioning his hand comfortably, in his lap. This mode of operation is particularly suitable for computer games, where much of the action is controlled by the computer mouse.

Referring further to the figures, FIG. 4B is a lateral view of tracking roller 26, arranged in a socket 34, on sleeve 24. At least two, and preferably three sensing rollers 42, arranged on rods 36, 38 and preferably also 40 sense the rolling direction of tracking roller 26. Socket 34 is preferably about 3 mm deep, and sensing rollers 42 are about 1 mm in diameter. It will be appreciated that somewhat larger or smaller dimensions are possible. It will be appreciated that socket 34 further includes related circuitry and components for tracking operation, as known.

Referring further to the figures, FIGS. 4C-4E are schematic illsutrations of index-finger computer mouse 22, wherien tracking roller 26 and first switches 28 are integrated, in accordance with a preferred embodiment of the present invention. This is suggested, for example, by U.S. Pat. No. 6,297,808, to Yang. As seen in FIG. 4D, in a lateral view, socket 34 includes at least rods 36 and 38, on which sensing rollers 42 are mounted. It will be appreicated that rod 40 (FIG. 4B) may similarly be included. As seen in FIG. 4E, in a vertical view, socket 34 further includes a switch 44, arranged, for example, on a leaf spring 46, to provide a clicking or a double clicking operation. It will be appreciated that socket 34 further includes related circuitry and components for tracking and clicking operations, as known.

It will be further appreciated that scrolling roller 29 and second switch 30 may similarly be integrated. Alternatively, tracking roller 26 may be integrated with second switch 30. Similarly, scrolling roller 29 may be integrated with first switch 28.

Referring further to the figures, FIG. 4F is a schematic illustration of index-finger computer mouse 22, having a vertical scrolling roller 29A for pageup and pagedown operations, and a lateral scrolling roller 29B, for scrolling from left to right, in accordance with a preferred embodiment of the present invention.

Referring further to the figures, FIGS. 4G and 4H are schematic illustrations of index-finger computer mouse 22, arranged as a cordless mouse, in accordance with a preferred embodiment of the present invention. Accordingly, cable 32 leads from mouse 22 to a wrist band 41, having a case 43. Case 43 includes at least one, and preferably two or more batteries 37, operative as the power provider to mouse 22, and a transmitter 39, operative as the communication provider from mouse 22 to computer 35 (FIG. 4A). Preferably, a recharging device (not shown) for case 43 is provided, to recharge at least one battery 37, for example, overnight.

It will be appreciated that case 43 may be arranged as a pendant, rather than on a wrist band. Alternatively, case 43 may be otherwise positoned on the user's person.

It will be further apreciated that transmitter 39 may be an RF or an infrared transmitter, as known.

Referring further to the figures, FIGS. 41 and 4J are schematic illustrations of index-finger computer mouse 22, arranged as a cordless mouse, in accordance with another preferred embodiment of the present invention. Accordingly, cable 32 is not used. Rather, mouse 22 includes at least one and preferably two or more minature batteries 37, as known, for example, watch batteries, operative as the power provider to mouse 22, and a minature transmitter 39, as known, operative as a communication provider from mouse 22 to computer 35 (FIG. 4A). Preferably, a recharging device (not shown) for index-finger computer mouse 22 is provided, to recharge at least one battery 37, for example, overnight.

In accordance with a preferred embodiment of the present invention, at least one battery 37 may be a PaperPower battery, provided by PaperPower, Kibbutz Einat, Israel. PaperPower batteries are environmentally friendly and disposable. A 1 cm×1 cm battery, having a thickiness of about 0.6 mm, has a voltage of 1.5 volts. PaperPower batteries may be provided at a desired size.

Preferably, as seen in FIG. 4J, sleeve 24 may be provided as a flat stip, to be arranged on index finger 12 with Vlecro ends 52, a snap, or the like. Additionally, PaperPower battery 37 may be arranged as an inner strip 37, held by a clip 54. Furthermore, an inner layer 25 of an absorbent material, such as cotton, or paper tissue, which is preferably disposable, may be used between sleeve 24 and finger 12, or between batteries 37 and finger 12, to prevent sweat builtup. Referring further to the figures, FIG. 5 is a cross sectional view of an index-finger computer mouse, showing tracking roller 26 in socket 34, on index finger 12, in accordance with a preferred embodiment of the present invention.

A height U of socket 34 may be about 3 mm, and a height V of tracking roller 26 and socket 34 may be about 7-8 mm. It will be appreciated that somewhat smaller or bigger dimensions are also possible.

Additionally, FIG. 5 illustrates sleeve 24 around finger 12, and preferably also, inner layer 25 of an absorbent material, between sleeve 24 and finger 12.

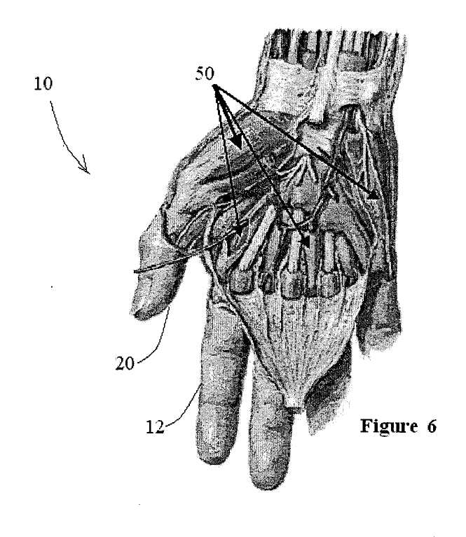

Referring further to the figures, FIG. 6 is an illustration of the intrinsic musculature of the hand, which control index-finger computer mouse 22, by the combined action of the thumb and the index finger. (F. H. Netter and A. D.

Dalley II, Atlas of Human Anatomy, 2d Edition, MediMedia USA, 1989, plate 429.) It will be appreciated that in the combined action of the thumb and index finger, the thumb may perform most of the action, working against the index finger. Alternatively, both the thumb and the index finger may work together, against each other.

The intrinsic musculature of the hand is more accurate and more sensible to joint movement, and does not cross the wrist joint. Overuse and overload of the tendons of the upper extremity, and in particular of the forearm, and their consequential orthopedic disorders, such as the carpal tunnel syndrome, tendinitis and bursitis are avoided.

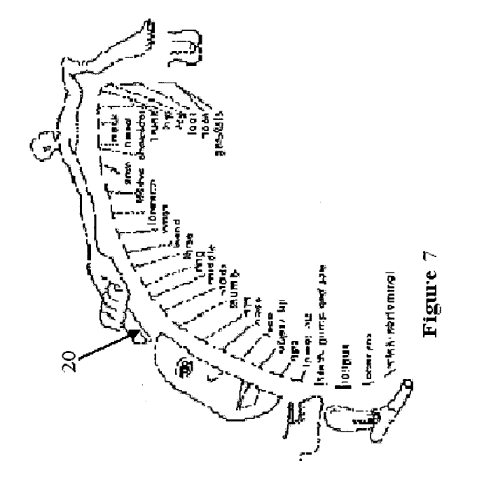

Referring further to the figures, FIG. 7 is an illustration of the sensory homunculus. (E. R. Kandel, J. H. Schwartz and T. M. Jessell, “Principles of Neural Science,” 3^{rd} edition, Appleton & Lange, 1991, Simon & Schuster Business and Professional Group, chapter 26, pp. 372.) FIG. 7 shows that the thumb is proportionally larger in sensory presentation, because of a large amount of sensory receptors on its skin, so as to be particularly suitable for fine sensing and fine tuning, necessary for the manipulation of mouse 22, such as that of tacking roller 26. As a result, there is little strain on the working muscles.

Additionally, according to E. R. Kandel, J. H. Schwartz and T. M. Jessell, “Principles of Neural Science,” 3^{rd} edition, Appleton & Lange, 1991, Simon & Schuster Business and Professional Group, chapter 26, p. 370, cells of the thumb and forefinger respond much more effectively to tactile stimuli than cells of the middle or the small fingers.

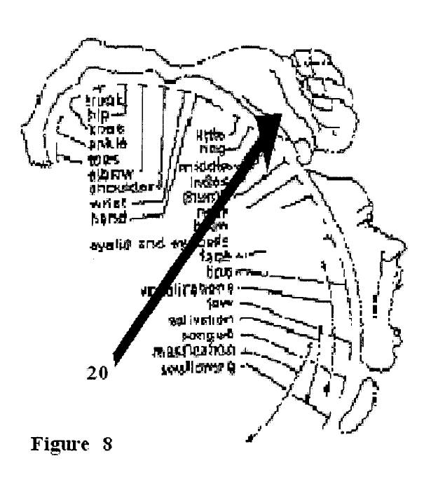

Referring further to the figures, FIG. 8 is an illustration of the motor homunculus. (E. R. Kandel, J. H. Schwartz and T. M. Jessell, “Principles of Neural Science,” 3rd edition, Appleton & Lange, 1991, Simon & Schuster Business and Professional Group, chapter 26, pp. 372.) FIG. 8 shows that the thumb is proportionally larger in motor presentation, so as to be all the more suitable for fine tuning, necessary for the manipulation of mouse 22.

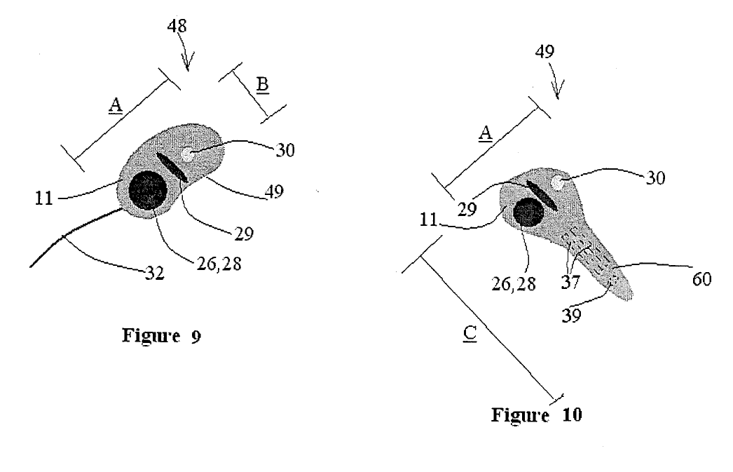

Referring further to the drawings, FIG. 9 is a schematic illustration of a miniature, finger computer mouse 48, arranged on substrate 11, in accordance with another preferred embodiment of the present invention. Accordingly, substrate 11 is formed as a pebble, adapted to be held between thumb 20 (FIG. 4A) and the fingers.

Preferably, finger mouse 48 has a kidney shape, resembling an oversized bean, and is ergonomically designed to be held comfortably between index finger 12 (FIG. 4A), middle finger 8, and thumb 20, so as to take advantage of the natural anatomic gripping position of the thumb and the fingers.

Alternatively, finger computer mouse 48 is ergonomically designed to be held comfortably between index finger 12 and thumb 20.

Finger mouse 48 may be cordless, and include miniature battery or batteries 37 and miniature transmitter 39. Preferably, a recharging device (not shown) for finger mouse 48 is provided, to recharge at least one battery 37, for example, overnight.

Alternatively, finger mouse 48 may include cable 32, leading to extension cable 33, or directly to computer 31.

In accordance with alternative embodiments of the present invention, finger mouse 48 may have an oval shape, a circular shape, or another suitable shape.

Preferably, substrate 11, forming finger mouse 48, may be a rigid or a semirigid material. A length A of finger mouse 48 may be about 3-6 cm and a width B may be about 2-3 cm. Finger mouse 48 may have a thickness (not shown) of between 2 mm and 3 cm. It will be appreciated that somewhat smaller or bigger dimensions are also possible.

Referring further to the drawings, FIG. 10 is a schematic illustration of a miniature, finger computer mouse 49, similar to finger mouse 48 hereinabove (FIG. 9), but having an extended portion 60, in accordance with still another preferred embodiment of the present invention. In particular, finger mouse 49 may be shaped after a mold of an inner space within a hand, when in a soft gripping position. Furthermore, different size molds may be used, for different size hands. Thus finger computer mouse 49 may be provided in a range of sizes.

Finger computer mouse 49 is ergonomically designed to be held comfortably between index finger 12 (FIG. 4A), middle finger 8, and thumb 20, so as to take advantage of the natural anatomic gripping position of the thumb and the fingers, while extended portion 60 rests against fingers 6 and 4. Alternatively, finger computer mouse 49 is ergonomically designed to be held comfortably between index finger 12 and thumb 20, while extended portion 60 rests against fingers 8, 6, and 4.

Preferably mouse 49 is cordless, and includes at least one, and preferably two batteries 37 and miniature transmitter 39, preferably within extended portion 60. Preferably, a recharging device (not shown) for finger computer mouse 49 is provided, to recharge at least one battery 37. The recharging device may be similar for example, to a cellular phone recharging device.

Extended portion 60 may be, for example, about 4-6 cm in length. It will be appreciated that somewhat smaller or bigger dimensions are also possible.

In a manner similar to the embodiments of FIGS. 4A-4J, the operation of finger computer mouse 48 of FIG. 9 and finger computer mouse 49 of FIG. 10 is controlled by the intrinsic musculature of the hand (FIG. 6), benefiting from their accurate sensitivity and fine motor control, and avoiding the orthopedic disorders associated with a regular mouse. The embodiments of FIGS. 9 and 10 may appeal to users who do not wish a computer implement on their person. On the other hand, these embodiments have the disadvantage that the finger mouse must be laid down and picked up every time a mouse operation is required.

In accordance with the present invention, the finger mouse of the embodiments described herein, in conjunction with FIGS. 4A-4J and 9-10, may be provided for left-hand or right hand operations. Additionally, different sizes may be provided, to accommodate different users, from small children to youths and adults.

It will be appreciated that the advantages of the finger mouse are:

work with the finger mouse eliminates wrist-extensor overload;

the highly developed sensory perception and motor accuracy of the thumb provides for improved accuracy in mouse manipulation and control;

neck and shoulder overload and stiffness are eliminated;

the hand may rest in a neutral position, for example, in the lap, while working with the mouse;

for mouse operation, the user does not require a desk, and may work from an armchair, or a sofa;

when working with the embodiments of any one of FIGS. 4A-4J, the hand need not be removed much from the keyboard, to operate the mouse.

It is expected that during the life of this patent many relevant finger computer mice will be developed and the scope of the term finger computer mouse is intended to include all such new technologies a priori.

As used herein the term “about” refers to ±10%.

As used herein the term “somewhat” refers to ±50%.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A finger mouse, worn on a finger of a user and operative with a computer, said finger mouse comprising:
a substrate;
a tracking roller, arranged on said substrate, for producing signals that control movements of a cursor on a screen of said computer;
a first switch, arranged on said substrate, for producing signals that control left-key mouse functions;
a second switch, arranged on said substrate, for producing signals that control right-key, mouse functions;
a communication provider, for transmitting said signals to said computer; and
a power provider, for providing power to said tracking roller, said first and second switches, and said communication provider,
wherein said finger mouse is adapted to be worn at a natural anatomic resting position of the thumb on the finger, and wherein said finger mouse is manipulated by a combined action of the thumb and the finger.

2. The finger mouse of claim 1, wherein said tracking roller and a switch, selected from the group consisting of said first and second switches, are incorporated together.

3. The finger mouse of claim 1, and further including a scrolling roller, manipulated by the combined action of the thumb and the finger.

4. The finger mouse of claim 3, wherein said scrolling roller and a switch, selected from the group consisting of said first and second switches, are incorporated together.

5. The finger mouse of claim 1, and further including a lateral scrolling roller and a vertical scrolling roller.

6. The finger mouse of claim 1, wherein said substrate is arranged on a sleeve that is worn about the finger.

7. The finger mouse of claim 1, wherein said substrate is arranged as a thimble that is worn about the finger.

8. The finger mouse of claim 1, and further comprising an inner, absorbent layer, placed between said substrate and the finger.

9. The finger mouse of claim 1, wherein said communication and power providers are arranged as:
a first cable, leading from said finger mouse to a mouse extension cable; and
said finger mouse extension cable, leading from said first cable to said computer,
wherein a connection point between said first cable and said finger mouse extension cable is easily accessible to a user.

10. The finger mouse of claim 1, wherein said communication and power providers are arranged on the user's person, and wherein said communication and power providers are connected to said finger mouse by a cable.

11. The finger mouse of claim 1, wherein said communication provider is a miniature transmitter, incorporated with said finger mouse.

12. The finger mouse of claim 1, wherein said power provider is at least one miniature battery, incorporated with said finger mouse.

13. The finger mouse of claim 1, wherein said power provider is at least one miniature paper-thin battery, incorporated with said finger mouse.

14. The finger mouse of claim 1, wherein said finger mouse is provided as an open strip, adapted to be fastened around the finger.

15. The finger mouse of claim 1, wherein said finger mouse is provided in a range of sizes.

16. A finger mouse, held between a thumb and at least one finger of a user and operative with a computer, said finger mouse comprising:
a substrate;
a tracking roller, arranged on said substrate, for producing signals that control movements of a cursor on a screen of said computer;
a first switch, arranged on said substrate, for producing signals that control left-key mouse functions;
a second switch, arranged on said substrate, for producing signals that control right-key, mouse functions;
a communication provider, for transmitting said signals to said computer; and
a power provider, for providing power to said tracking roller, said first and second switches, and said communication provider,
wherein said finger mouse is adapted to be held at a natural anatomic gripping position of the thumb on the finger, and wherein said finger mouse is manipulated by a combined action of the thumb and the at least one finger.

17. The finger mouse of claim 16, wherein said tracking roller and a switch, selected from the group consisting of said first and second switches, are incorporated together.

18. The finger mouse of claim 16, and further including a scrolling roller, manipulated by the combined action of the thumb and the finger.

19. The finger mouse of claim 18, wherein said scrolling roller and a switch, selected from the group consisting of said first and second switches, are incorporated together.

20. The finger mouse of claim 16, and further including a lateral scrolling roller and a vertical scrolling roller.

21. The finger mouse of claim 16, wherein said communication and power providers are arranged as:
a first cable, leading from said finger mouse to a mouse extension cable; and
said finger mouse extension cable, leading from said first cable to said computer,
wherein a connection point between said first cable and said finger mouse extension cable is easily accessible to a user.

22. The finger mouse of claim 16, wherein said communication and power providers are arranged on the user's person, and wherein said communication and power providers are connected to said finger mouse by a cable.

23. The finger mouse of claim 16, wherein said communication provider is a miniature transmitter, incorporated with said finger mouse.

24. The finger mouse of claim 16, wherein said power provider is at least one miniature battery, incorporated with said finger mouse.

25. The finger mouse of claim 16, wherein said finger mouse is shaped after a mold of an inner space within a hand, when in a soft gripping position.

26. The finger mouse of claim 16, wherein said finger mouse is provided in a range of sizes.

27. A method of controlling a computer mouse by the intrinsic musculature of the hand, said method comprising:
providing a finger mouse, worn on a finger of a user and operative with a computer, said finger mouse comprising:
a substrate;
a tracking roller, arranged on said substrate, for producing signals that control movements of a cursor on a screen of said computer;
a first switch, arranged on said substrate, for producing signals that control left-key mouse functions;
a second switch, arranged on said substrate, for producing signals that control right-key, mouse functions;
a communication provider, for transmitting said signals to said computer; and
a power provider, for providing power to said tracking roller, said first and second switches, and said communication provider,
wherein said finger mouse is adapted to be worn at a natural anatomic resting position of the thumb on the finger, and wherein said finger mouse is manipulated by a combined action of the thumb and the finger;
positioning said finger mouse on the finger, at a natural anatomic resting position of the thumb on the finger; and
manipulating said finger mouse by the combined action of the thumb and the finger.

28. The method of claim 27, wherein the finger is an index finger.

29. The method of claim 27, wherein the finger is a middle finger.

30. A method of controlling a computer mouse by the intrinsic musculature of the hand, said method comprising:
providing a finger mouse, adapted to be held between a thumb and at least one finger of a user and operative with a computer, said finger mouse comprising:
a substrate;
a tracking roller, arranged on said substrate, for producing signals that control movements of a cursor on a screen of said computer;
a first switch, arranged on said substrate, for producing signals that control left-key mouse functions;
a second switch, arranged on said substrate, for producing signals that control right-key, mouse functions;
a communication provider, for transmitting said signals to said computer; and
a power provider, for providing power to said tracking roller, said first and second switches, and said communication provider,
wherein said finger mouse is adapted to be held at a natural anatomic gripping position of the thumb on the finger, and further wherein said finger mouse is manipulated by a combined action of the thumb and the at least one finger;
positioning said finger mouse between the thumb and the at least one finger, at a natural anatomic resting position of the thumb on the at least one finger; and
manipulating said finger mouse by the combined action of the thumb and the at least one finger.

31. The method of claim 30, wherein the at least one finger is an index finger.

32. The method of claim 30, wherein the at least one finger is a middle finger.

33. The method of claim 30, wherein the at least one finger includes an index finger and a middle finger.
